(19) United States
(12) Patent Application Publication
(10) Pub. No.: US 2003/0152248 A1
(43) Pub. Date: Aug. 14, 2003

(54) Self calibration of an array of imaging sensors

(76) Inventors: Peter Edmunds Spark, Wangfield (GB); Christopher John Gillham, Hampshire (GB); Christopher Harris, Winchester (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/257,449

(22) PCT Filed: Apr. 9, 2001
(86) PCT No.: PCT/EP01/04097

(30) Foreign Application Priority Data
Apr. 11, 2000 (GB) 008739.5
Mar. 30, 2001 (GB) 0108482.1

(51) Int. Cl. G06K 9/00

(52) U.S. Cl. 382/103

(57) ABSTRACT

A method of calibrating one or more image sensors in terms of position and/or attitude comprising capturing the image of a moving object such as an aircraft at one or more locations determining the 2-d position on the image (sensor). The 3-d position of the aircraft may be known or unknown. The moving object may be captured at a number of locations to improve accuracy.

This invention relates to a method of self calibration of imaging sensors. Imagining sensors (e.g. a camera) are used to passively monitor detectable objects, such as aeroplanes, for example by ‘hot-spot’ or motion detection. It is envisaged that a self-calibrating array of imaging sensors could be used for a warning system in an air defence role. Radar systems suffer from the disadvantage of being active (they transmit signals), they thus make themselves targets. Consequently to preserve the system it may be required to turn itself off. Acoustic systems can provide no advance warning of objects travelling at super-sonic speeds. Imaging sensors, being passive, do not give away their position in operation.

In known systems, image sensors and processing modules perform object detection for instance using, the motion of the object or the presence of the hot exhaust (for infra-red imaging sensors). This information can be transmitted (for example using a land line, or directional radio communication) to a central point where the detection from a number of image sensors is correlated and the position and track of the object is calculated. However, a single sensor will not give a good indication of range, speed and direction of flight. The object must be observed by two or more sensors, allowing triangulation to be performed. The attitude of each sensor must be known to a sufficient accuracy. The position and attitude of a sensor is called its calibration. This calibration could be achieved by surveying them, but under adverse deployment conditions (e.g. in enemy territory, or for hasty deployment) adequate surveying may not be practicable.

In combat scenarios such sensors imaging, may be dropped remotely by parachute, by personnel on the ground, or other suitable means.

It is an object of the invention to overcome this problem and to provide a method for the image sensors to calibrate themselves.

The invention comprises a method of calibrating one or more image sensor in terms of position and/or attitude comprising:

a) capturing the image of a moving object at one or more locations.

b) determining the corresponding 2-d position on said image (sensors).

c) from the data obtained in steps a) & b) calculating the position and/or attitude of the sensor.

In this way the invention uses a moving object of opportunity, e.g. an aircraft to calibrate the image sensors.

If possible, it is preferable if the 3-d position of the moving object the locations is known. This may be achieved by the aircraft relating its position to the image sensors, if not a hostile aircraft (most aircraft have GPS which enable the aircraft to locate the aircraft's position). Alternatively the 3 D co-ordinates, or estimates therefor, may be determined by a radar system and indirectly which communicates these data to the sensors.

Where a single sensor calibrates itself and no other data are available, in step a) there needs to be a minimum of three locations, and the aircraft's position needs to be known at these locations too.

The number of location of capture can be reduced to one or two if ancillary sensor information is also known.

The ancilliary sensor information maybe sensor position or attitude, or an estimate of one or both of attitude and position. Alternatively the ancillary sensor information, is obtained by capturing the 2-d position on said image sensor of a fixed known reference point.

The invention is also applicable to the case where the position of the moving object not known. Normally to calibrate a single image sensor and the moving object needs to be captured at least is captured at least 5 locations for it calibration. Again ancillary sensor in for motion will also help improve the accuracy of the calibration and reduce the number said locations of capture.

It is advantageous also for there to me a plurality of sensors working together to calibrate themselves. Under these circumstances the moving object is captured on the image sensors at the same time, i.e. corresponding to the same location. One or more sensors of such a system may have their location and/or attitude already know or determined. If both the location and attitude of a sensor in such systems is known it does obviously not need calibrating but assists to calibrate other sensors. Alternatively only one of either attitude or position of one or more or all of the sensors is not know, or only estimated.

### EXAMPLE 1

### Known Moving Object Location

Consider a plurality of imaging sensors that have at least partially overlapping fields of view. Each sensor is self-calibrated independently, so one needs only to consider for a single sensor. To perform self-calibration, the sensor will require a number of views of a target whose 3D position is known. The target may be a co-operating aircraft whose location is known for example by an on-board GPS, or any target whose location is determined using for example radar.

Consider n (at least 3) observations being taken of the target. To start off, select 3 observations that are not in a 3D straight line, and using these, apply a closed-form technique (known to those skilled in the art, for example, one technique requires solving a quartic equation) to determine the sesnor calibration. This will not in general result in a very accurate calibration, but it can be improved by incorporating the remaining n−3 observations. For example, this can be performed by using an extended Kalman Filter initialised with the closed-form solution. The parameters of the Kalman Filter will be the sensor attitude (for example, roll, pitch and yaw) and sensor location (for example elevation, latitude and longitude). It is at this point that the sensor elevation may be constrained to lie on the ground surface as specified by the terrain map. The closed-form solution may be omitted if an adequate initial estimate of the calibration is available, and the observations incorporated directly into the Kalman Filter.

### EXAMPLE 2

In the following example there are two image sensors (or cameras) 1 & 2 whose exact position and orientation is unknown. The cameras are self-calibrated according to the accurately known (i.e calculated) position of an object, for example, a co-operating aircraft flying along a flight path which can determine its own location by some method e.g. it may have a GPS receiver.

At known position ‘A’, having 3-d co-ordinates X_{A}, Y_{A}, Z_{A} the aircraft can be observed at a location point (x_{1A}, y_{1A}) on the 2 dimensional image sensor and position x_{2A}, y_{2A} (2 dimensional) on image sensor 2. The aircraft is observed at two further locations (B and C) and the values of X, Y, Z, x, y, and are determined for each sensor at each location. Thus for each location and each sensor the variables XYZ, x, y are known.

The variables which are unknown and which require to be determined are for each of the two sensors, α and β (the effective x, y co-ordinates of the sensor, i.e. 2 dimensional location on a map) and χ, β, λ the effective pitch, roll and yaw values of the sensors—i.e. orientation

When there are two sensors and three measured points α, β, χ, δ and λ for each sensor can be determined for each from the 3 sets of values X, Y, Z x, y.

where A, B, C refers to position of object aircraft and 1 & 2 refers to sensor number.

| X_{A}, Y_{A}, Z_{A} | X_{B}, Y_{B}, Z_{B} | X_{C}, Y_{C}, Z_{C} |
|---|---|---|
| x_{1A}, y_{1A} | x_{1B}, y_{1B} | x_{1C}, y_{1C} |
| x_{2A}, y_{2A} | x_{2B}, y_{2B} | x_{2C}, y_{2C} |

The above known variables (21 in total) are used to solve the unknown α, β, χ, δ, and λ for each sensor (10 unknowns). Suitable mathematical techniques to solve this would be clear to the person skilled in the art and include techniques such as Kalman filters to determine the 2 exact closed-form solutions for the sensor calibration. For each solution, for example, a Kalman Filter for the sensor calibration can be initiated and sequentially all the additional observations added in, and the sensor calibration refined.

Preferably the three observations are not bunched together or on a straight line. It is not necessary that the aircraft is friendly, as long as its position at a time is known. Its position may, e.g., be determined by radar.

Calibration can still be achieved even if a known object is not available, provided that at least approximate sensor calibrations are available. For example, sensor location may be known approximately (or accurately known) by use of on-board GPS receivers. Sensor attitude may be approximately known due to the method of deployment (e.g. self righting unit—so the sensor always points roughly vertically) or by using additional instrumentation e.g. compass (for azimuth), and tilt meters (for elevation). A moving object such as an aircraft assumed to be the same and observed additionally by a sensor whose position and orientation is known. This would yield information allowing to improve the estimate of position and orientation of the imaging sensor. Whose calibration is unknown even where both imagining sensors have errors in an assumed attitude and/or position, it is still possible to improve their estimates. In general any errors generated would then be compared to those generated an assumimg various positions and attitudes; and as a result of the comparison the optimum estimate of actual location may be determined where the errors are iterated to zero or a minimum. An example is described in the following example.

### EXAMPLE 3

### Unknown Moving Object Locations

Even if the moving object 3-D locations are not known, a calibration can still be performed provided that there is sufficient overlap in the sensor fields of view. Assume to start with that a moving object seen in 2 or more sensors is correctly identified—that there is no confusion between different targets. The determination of the sensor calibrations is then equivalent to that of fibre-bundle adjustment in photogrammetry. This requires the construction of a mathematical model of all the sensor calibrations and all target 3D locations. By projecting the targets into each sensor, and iteratively minimising their differences to the observations, an optimal solution can be found. This technique is known to those skilled in the art.

It is most useful, for the techniques to have initial estimates for the sensor calibrations to start the iterative minimisation. Without the use of additional measurements, only relative sensor calibrations can be obtained—for example, shifting all the sensors by an identical amount in any direction will be an equally valid solution. This is an example of the so-called speed-scale ambiguity. This ambiguity can be resolved by use of the terrain map and the assumption that all the sensors are on the ground, provided that the sensor altitudes are sufficiently diverse.

There remains the problem of resolving confusion between moving objects. It shall be assumed that each sensor has accurate knowledge of time, by use of an on-board clock or a GPS clock. Only targets seen simultaneously in 2 or more sensors will normally provide useful calibration data.

One simple method is to use occasions when at most only a single moving object is observed in each sensor. If this is due to the presence of a single moving object in the monitored space, then the target will indeed be correctly identified. The occurrence of one or more of such single-moving object events may enable calibration to be performed, depending on the sinuosity of the target flight-path. It may be that more than one moving object is present in some of these events so that incorrect identification occurs, leading to an inconsistent calibration. This problem could be overcome by employing a RANSAC algorithm to work with subsets of these events.

The resolution of confusion between moving objects is aided by forming target tracks in each sensor. Provided these tracks do not cross, all observations along a track should originate from the same target (though at different times). Even when tracks cross, it may be possible to correctly identify them.

The shapes of these tracks in the image may provide disambiguating information. For example, an aircraft flying at constant velocity will form a straight track, which should not be matched to a distinctly curved track seen in another sensor.

It may be that the target is not observed as a simple point event, but has useful identifying attributes. For example, in an infra-red sensor, the intensity of a jet aircraft may change suddenly as afterburners are turned on. Identification of this same track attribute in different sensors would be evidence of track matching.

Prior estimates of the sensor calibration may be used to disambiguate moving objects. A prior calibration estimate for a sensor may act to localise a moving object in a volume of space, so that if these volumes do not overlap between sensors, then the moving object cannot be in common. For tracks, an overlap region must exist at all times for correct matching.

In some instances additional information may be utilised to improve the accuracy of the estimation. This may include observation by the image sensor of fixed reference point such as mountain peaks stars etc.

Self-calibration in general, can be performed using a number of examples of objects of opportunity seen by the sensors. To be of use, each object should preferably be seen by at least 2 sensors, and be correctly identified in each sensor as the same object.

A filter (e.g. a Kalman Filter) can be constructed for both the sensor calibrations and a general object position. The filters are initialised to the approximate sensor calibrations. Each set of object observations is first used to estimate the object position, then used to refine the (linearised) filter.

1. A method of calibrating one or more image sensors in terms of position and/or attitude comprising:
(a) capturing the image of a moving object at one or more locations;
(b) determining the corresponding 2-d position on said image sensors;
(c) from the data obtained in steps (a) & (b) calculating, the position and/or attitude of the one or more sensors.

2. A method as claimed in claim 1, wherein in step (a) the 3-d position of the moving object at at least one location is known.

3. A method as claimed in claims 1 or 2, wherein the method is used to calibrate one image sensor and in step (a) the number of locations of capture is at least three.

4. A method as claimed in claims 1 or 2, wherein step (a) the number of locations of capture is one or two, and in step (c) ancillary sensor information is also known and used in said calculation.

5. A method as claimed in claims 1 or 2, wherein at least 2 image sensors are used in the calibration and in step (c) ancillary sensor information is also known and used in said calculation.

6. A method as claimed in claims 2-5, wherein said moving object transmits positional data directly to said image sensor.

7. A method as claimed in claim 1, wherein the position of the moving object not known.

8. A method as claimed in claim 1, wherein the method is to calibrate a single image sensor and the moving object is captured at least 5 locations.

9. A method as claimed in claims 4-7, or 8, wherein said ancillary sensor information is position or attitude, or an estimate of one or both of attitude and position, of the single or at least one of the plurality of sensors.

10. A method as claimed in claims 4-7, 8 or 9, wherein said ancillary sensor information is obtained by capturing the 2-d position on said image sensor of a fixed known reference point.

11. A method as claimed in any preceding claim wherein said moving object is a helicopter or air craft.
